(19) United States
(12) Patent Application Publication
(10) Pub. No.: US 2025/0027887 A1
(43) Pub. Date: Jan. 23, 2025

(54) SYSTEMS AND METHODS FOR INSPECTING A SUBSTRATE

(71) Applicant: Applied Materials, Inc., Santa Clara, CA (US)

(72) Inventors: Srikanth V. Racherla, Fremont, CA (US); Ashish Singh Raichur, San Jose, CA (US); Jaeyoung Kim, Yongin-si (KR); Makoto Inagawa, Palo Alto, CA (US)

(21) Appl. No.: 18/742,909

(22) Filed: Jun. 13, 2024

Related U.S. Application Data
(60) Provisional application No. 63/514,509, filed on Jul. 19, 2023.

(51) Int. Cl. G01N 21/956; G01N 21/88; G01N 21/95; G01N 35/00

(52) U.S. Cl. CPC G01N 21/95684; G01N 21/8851; G01N 35/00613; G01N 2021/8861; G01N 2021/8887; G01N 21/9501; G01N 2201/1296

(57) ABSTRACT

A load lock system including an imaging subsystem and an image processing subsystem to capture comprehensive data of a substrate within a load lock chamber. The imaging subsystem can include multiple imaging elements (e.g. cameras or image sensors), to capture image data of a substrate. The image processing subsystem can process the image data with a number of computer vision, or feature extraction techniques to identify nonconformities associated with the substrate. These nonconformities can include chips, breaks, scratch, placement errors, orientation errors, or a number of other errors associated with the substrate and substrate components. The image processing subsystem can further output a message indicating any one of these errors have occurred.

### RELATED APPLICATIONS

This application claims the benefit of U.S. Provisional Patent Application No. 63/514,509, filed Jul. 19, 2023, the entire contents of which are hereby incorporated by reference herein.

### TECHNICAL FIELD

Embodiments of the present disclosure relate generally to an image capture and processing system associated with a load lock chamber for transitioning a substrate to further processing chambers, and in particular to an image capture and processing system for performing substrate diagnostics.

### BACKGROUND

An electronic device manufacturing system can include a variety of manufacturing spaces. In some cases, these spaces can be uniquely monitored, or isolated to perform different and complex manufacturing processes associated with manufacturing a substrate. In some cases, these spaces can be transfer areas, or waiting areas, or any other areas of the like.

By way of example, one of these spaces can include a factory interface (which may be, e.g., an equipment front end module (EFEM), an atmospheric robot interface (ATM Robot IF), etc.) configured to receive substrates upon which electronic devices may be manufactured. A second of these spaces can be a transfer chamber for transferring substrates to and from process chambers. A third, distinct space can be one or more load lock chambers separating the transfer chamber from the factory interface.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a load lock system is provided. The load lock system comprises a load lock chamber comprising a substrate support device configured to support a substrate; and an imaging element to capture image data reflective of a profile of the substrate. The load lock system further comprises a computing subsystem configured to process the captured image data reflective of the substrate profile, identify a feature associated with the substrate profile via the captured image data, identify characteristic data of the feature associated with the substrate profile, and generate a report on the feature associated with the substrate profile. In some aspects, the report comprises the characteristic data of the feature, based on the processed image data.

In an aspect of the disclosure, a method is provided for identifying a feature of a substrate profile. The method comprises, capturing image data reflective of a substrate profile of a substrate within a load lock chamber. In some aspects, the load lock chamber comprises a substrate support device configured to support a substrate and an imaging element to capture image data reflective of a profile of the substrate. The method further comprises processing the captured image data via a computing subsystem, identifying a feature associated with the substrate profile via the captured image data, identifying characteristic data of the feature associated with the substrate profile, and generating a report on the feature associated with the substrate profile, wherein the report comprises characteristic data of the feature, based on the processed image data.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

The drawings, described below, are for illustrative purposes only and are not necessarily drawn to scale. The drawings are not intended to limit the scope of the disclosure in any way.

FIG. 1 illustrates an exemplary embodiment of a diagram of a cluster tool, including a load lock chamber, and its placement among other processing chambers and equipment in a factory setting.

FIG. 2A illustrates a top-down view of an exemplary embodiment of a load lock chamber.

FIG. 2B illustrates a cut-away side view of an exemplary embodiment of a load lock chamber.

FIG. 3 illustrates an exemplary embodiment of an image capture and processing subsystem.

FIG. 4 illustrates an exemplary method for detecting a crack in a substrate, an exemplary method for detecting a chip in a substrate, and an exemplary method for measuring the angle of a substrate within a load lock chamber.

FIG. 5 illustrates an exemplary method for detecting a buffer area, an exemplary method for detecting a buffer area in an advanced manner, and an exemplary method for detecting leakage in the buffer area.

FIG. 6 illustrates an exemplary embodiment of an imaging element.

FIG. 7 illustrates an embodiment of a diagrammatic representation of a computing device associated with a substrate manufacturing system.

### DETAILED DESCRIPTION

In a typical use of the device, a load lock chamber can serve to isolate a section of spaces of the manufacturing system (e.g. the transfer chamber and processing chambers) that must be kept at pressures and contamination levels much different than those found generally in the factory system setting, or the electronic device manufacturing system at large. In some ways, a load lock chamber can serve similar purposes as an airlock, and act as a transition space for end products such as substrates, as they are transferred from a first environment with first conditions to a second environment with very different second conditions.

By way of example, pressure settings within the factory setting can be at atmospheric pressure, while pressure settings within process chambers and the transfer chambers can be almost at vacuum level. As such, a load lock chamber can act as an airlock, by first, accepting substrates form an atmospheric pressure environment, second, sealing the load lock chamber off from any exterior environment, third, modifying the pressure within the load lock chamber to match that of the transfer chambers and processing chambers, and then fourth, opening a second set of doors leading to the transfer chambers and processing chambers so the substrate can be transferred into these spaces.

As one can imagine, some manufacturing spaces, including, for example, the load lock chamber, processing chambers, transfer chamber, factory interface, and the factory at large, can make use of a variety of complex computing, chemical, and mechanical systems. These spaces and systems may require routine maintenance to function at a high-level.

Part and subsystem degradation is a major focus for system maintenance. Conditions and/or components of any of these spaces can degrade. The processing chambers can degrade. The factory interface can degrade. The load lock chamber, transfer chamber, and any other spaces or systems of the electronic device manufacturing system can degrade. By way of one example, for instance, a single load lock chamber may accumulate contaminates (e.g. such as dirt or other particles), components within and of the load lock chamber may mechanically deteriorate or fail, and so on.

Such degradations within the load lock chamber space or any other spaces may directly and negatively affect the finish quality of the processed substrates of the electronic device manufacturing system. By way of example, such degradation may introduce abnormalities associated with the substrates of the system. Some of these associated abnormalities can be substrate-level defects, including substrate body-level defects such as substrate chipping or scratching, or breaking, or substrate deposition level defects, such as dimensional offsets between the intended deposition pattern on the substrate, and the actual deposition pattern on the substrate. Many other abnormalities including substrate defects and misplacements can be introduced through degradation of the manufacturing system spaces and systems.

Thus, decreased integrity of the manufacturing system spaces and systems may correlate to inconsistencies and inadequacies in finished products, or finished substrates, and substrates must be continually qualified to ensure whether system degradation is to a point that unacceptably affects the finish quality of a substrate.

Current methods for qualifying the integrity of a processed substrate include scanning a substrate when it is within a load lock chamber. This method faces some challenges that make it hard to identify some inconsistencies and defects associated with a substrate. For example, current methods for qualification include use of a laser sensor e.g., a solid-state laser (SSL) sensor. A laser sensor, such as an SSL, can be placed at each corner of the load lock chamber to examine each of the four corners of a single rectangular substrate. Such an approach introduces challenges in data collection by way of scanning limitations of the laser sensor technology used to scan the substrate. Such an approach further provides very limited information.

By way of example, the laser sensors employed in the load lock chamber may produce a laser beam that is very narrow and has a very limited visual granularity of the field of view (FOV). The laser beam produced by the laser sensor can be a circular beam with a diameter on the order of around 2 mm, and the laser sensor may not be able to sense defects that are smaller than this circular area, or aspects that are generally small.

Furthermore, current systems relying on laser sensor technology may have no way of detecting some types of defects commonly affecting substrates. By way of example, laser sensors may have no way to detect deposition pattern errors, including errors such as deposition leakage, positional offsets in shadow frame seating, or errors in a substrate placement in a load lock chamber. Current systems using laser sensor technology may, in fact, only be able to detect large breaks or cracks within the substrate.

Properly identifying these kinds of defects is advantageous for substrate manufacturing processes. Identifying and addressing complications in a preventative manner, before they cause more serious problems and breakages in further manufacturing processes, provides increases in part and process longevity, increased throughput and efficiency, as well as decreases in system down time.

Embodiments of the present disclosure relate to a novel and comprehensive type of sensing system. In some cases, this novel sensing system can make use of a number of imaging elements within a load lock chamber, to capture image data (e.g. a host of pixel data) associated with a substrate (or with the image profile of a substrate) and transfer the captured image data to an associated computing subsystem for image processing.

Through the use of modern image analysis techniques (e.g. edge detection, denoising, etc.) that would not be possible without modern imaging elements, associated image processing systems can vastly increase the detection capabilities over current systems. In some cases, the image processing subsystem can accurately identify substrate features, including breakage in a substrate, edge chipping in a substrate, and cracks within a substrate, misplacement of a substrate, leakage from the substrate deposition area, or offsets in the substrate deposition area, just to name a few of the detection capabilities. Thus, a computing subsystem, coupled with an image processing subsystem and imaging elements within the load lock chamber, expand the capabilities for identifying defects over current systems in a way that promotes system integrity, system maintenance, and the quality of finished substrates.

The components of the embodiments as generally described and illustrated in the figures herein can be arranged and designed in a wide variety of different configurations. Thus, the detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated. The phrase “coupled to” is broad enough to refer to any suitable coupling or other form of interaction between two or more entities, including direct and/or indirect mechanical, fluidic and thermal interaction. Thus, two components may be coupled to each other even though they are not in direct contact with each other. The phrases “attached to” or “attached directly to” refer to interaction between two or more entities which are in direct contact with each other and/or are separated from each other only by a fastener of any suitable variety (e.g., mounting hardware or an adhesive). The phrase “fluid communication” is used in its ordinary sense and is broad enough to refer to arrangements in which a fluid (e.g., a gas or a liquid) can flow from one element to another element when the elements are in fluid communication with each other.

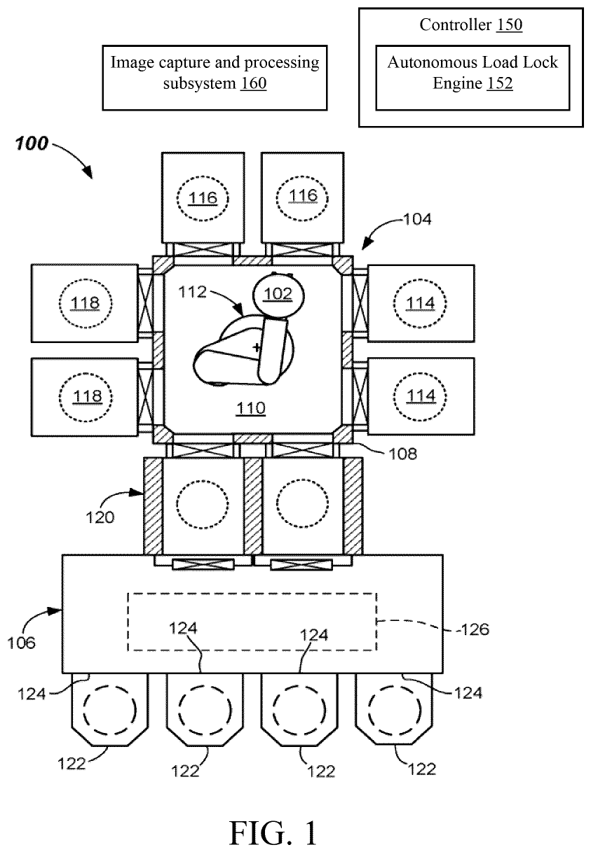

Referring now to the figures, FIG. 1 is a diagram of a cluster tool (also referred to as a system, substrate processing system or manufacturing system), including a load lock system, and its placement among other processing chambers and equipment in a factory setting in accordance with at least some embodiments of the disclosure. The system is configured for substrate fabrication in accordance with at least some embodiments of the disclosure.

In an exemplary embodiment, cluster tool 100 may comprise a processing portion 104, a transfer chamber 110, a load lock system 120, a factory interface 106, and substrate carriers 122 (e.g. a glass carrier) or front opening unified pods (FOUPs). Processing portion 104 may comprise a plurality of process chambers 114, 116, and 118, wherein specific and controlled substrate manufacturing processes occur. Transfer chamber 110 may house a transfer robot arm 112 comprising a substrate transfer mechanism, or end effector (substrate transfer mechanism and end effector will be used interchangeable moving forward in the disclosure) that may transport substrates 102. Transfer chamber 110 may be in transfer chamber housing 108. Load lock system 120 may interface with both the processing portion 104 and the factory interface 106. Factory interface 106 may comprise a factory interface robot 126, for transferring substrates to and from the carriers 122 and the load lock system 120. Factory interface may further comprise a plurality of load ports 124 for receiving carriers 122 carrying one or more substrates. Transfer chamber 110 is generally maintained at vacuum pressure levels, while factory interface 106 is generally maintained at atmospheric pressure.

In some embodiments, transfer chamber 110, process chambers 114, 116, and 118, and load lock chambers of load lock system 120 may be maintained at a vacuum level. The vacuum level for the transfer chamber 110 may range from about, e.g., 0.01 Torr (10 mTorr) to about 80 Torr. Other vacuum levels may be used.

The factory interface robot 126 is configured to transfer the substrate from the carriers 122 (FOUPs) to load lock chambers of load lock system 120 through load lock chamber doors. The number of load lock chambers can be more or less than two but for illustration purposes only, two load lock chambers of load lock system 120 are shown with each load lock chamber having a door (e.g., a slit valve) to connect it to the factory interface 106 and a door to connect it to the transfer chamber 110. Load lock system 120 may or may not be batch load lock chambers. In embodiments, the load lock chambers are smart load lock chambers capable of performing self-diagnosis and/or automated prevention and/or recovery.

The load lock system 120, under the control of a controller 150, can be maintained at either an atmospheric pressure environment or a vacuum pressure environment, and serve as an intermediary or temporary holding space for a substrate that is being transferred to/from the transfer chamber 110. The transfer chamber includes robot arm 112 that is configured to transfer the substrate from the load lock chambers to one or more of the plurality of processing chambers 114, 116, 118 (also referred to as process chambers), or to one or more pass-through chambers (also referred to as vias), without vacuum break, i.e., while maintaining a vacuum pressure environment within the transfer chamber 110 and the plurality of processing chambers 114, 116, 118.

A door, e.g., a slit valve door, connects each respective load lock chamber of load lock system 120 to the transfer chamber 110. The plurality of processing chambers 114, 116, 118 are configured to perform one or more processes. Examples of processes that may be performed by one or more of the processing chambers 114, 116, 118 include cleaning processes (e.g., a pre-clean process that removes a surface oxide, debris, or other impurities from a substrate e.g., such as a glass substrate used to form a display device), anneal processes, deposition processes (e.g., for deposition of a cap layer, a hard mask layer, a barrier layer, a bit line metal layer, a barrier metal layer, for an electrode layer, etc.), etch processes, and so on. Examples of deposition processes that may be performed by one or more of the process chambers include physical vapor deposition (PVD), chemical vapor deposition (CVD), atomic layer deposition (ALD), and so on. Examples of etch processes that may be performed by one or more of the process chambers include plasma etch processes. One of ordinary skill in the art, having the benefit of this disclosure will recognize that this list is not comprehensive, or linear, with respect to substrate (including display and glass substrate) manufacturing; other commonly used processes associated with a processing chamber and electronic device manufacturing (including display device manufacturing) may be included in the above examples.

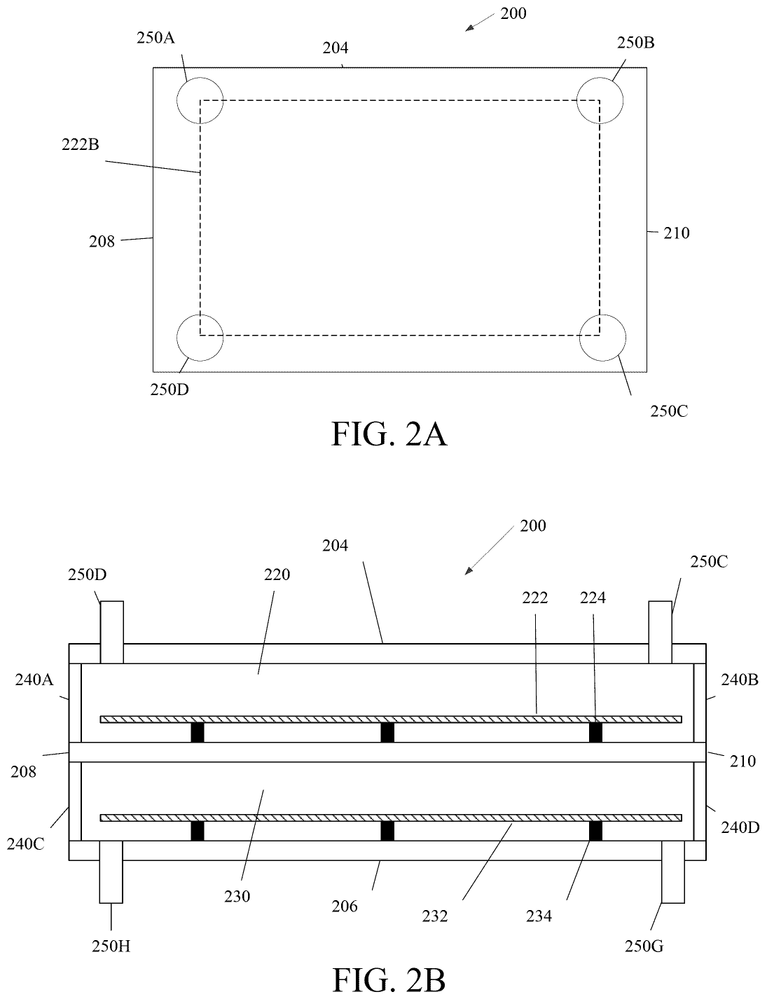

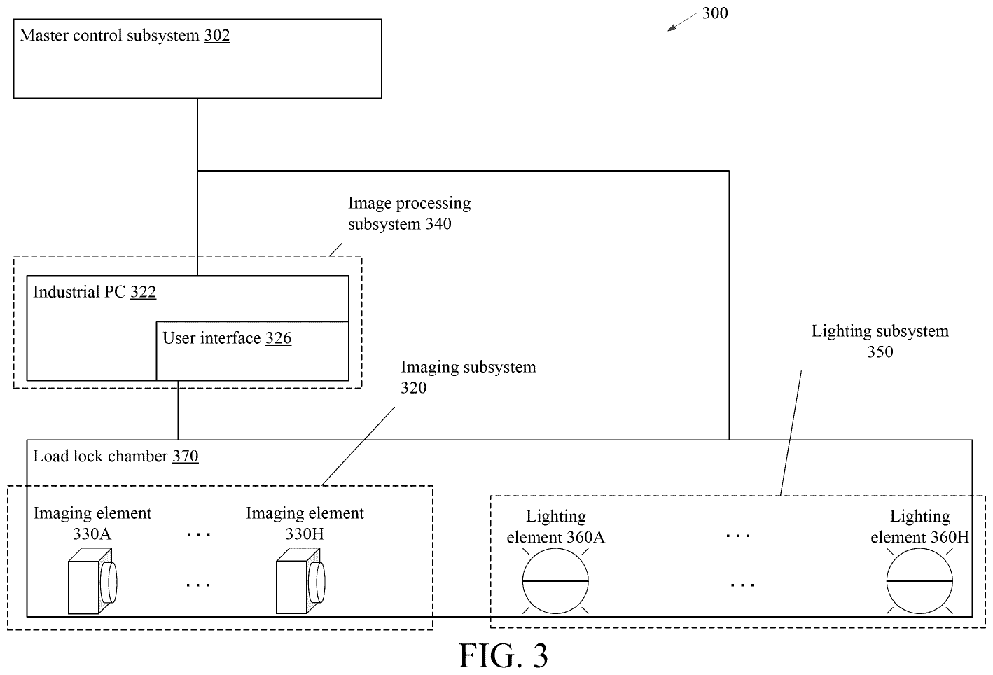

Controller 150 (e.g., a tool and equipment controller, a tool cluster controller, etc.) may control various aspects of the cluster tool 100, e.g., gas pressure in the processing chambers, individual gas flows, spatial flow ratios, plasma power in various process chambers, temperature of various chamber components, radio frequency (RF) or electrical state of the processing chambers, and so on. The controller 150 may receive signals from and send commands to any of the components of the cluster tool 100, such as the robot arm 112, factory interface robot 126, process chambers 114, 116, 118, load lock chambers of load lock system 120, slit valve doors, and/or one or more sensors, and/or other processing components of the cluster tool 100. The controller 150 may thus control the initiation and cessation of processing, may adjust a deposition rate and/or target layer thickness, may adjust process temperatures, may adjust a type or mix of deposition composition, may adjust an etch rate, may initiate automated prevention and/or recovery processes on the load lock chambers, and the like. The controller 150 may further receive and sensor measurement data (e.g., optical measurement data, vibration data, spectrographic data, particle detection data, temperature data, etc.) from various sensors and make decisions based on such measurement data. The controller may further be coupled with and communicate with an image capture and processing subsystem 160 (as will be further described in FIGS. 2A-2B, and FIG. 3), to gather and process imaging data associated with a substrate within any one of the load lock chambers.

In various embodiments, the controller 150 may be and/or include a computing device such as a personal computer, a server computer, a programmable logic controller (PLC), a microcontroller, and so on. The controller 150 may include (or be) one or more processing devices, which may be general-purpose processing devices such as a microprocessor, central processing unit, or the like. More particularly, the processing device may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device may also be one or more special-purpose processing devices such as an application specific integrated circuit (ASIC), a field programmable gate array (FPGA), a digital signal processor (DSP), network processor, or the like. The controller 150 may include a data storage device (e.g., one or more disk drives and/or solid-state drives), a main memory, a static memory, a network interface, and/or other components. The processing device of the controller 150 may execute instructions to perform any one or more of the methodologies and/or embodiments described herein. The instructions may be stored on a computer readable storage medium, which may include the main memory, static memory, secondary storage and/or processing device (during execution of the instructions). In some embodiments, controller 150 is a dedicated controller for load lock system 120.

In embodiments, the processing device and memory of controller 150 have an increased capacity as compared to processing power and memory size of traditional controllers for cluster tools. In embodiments, the processing device and memory are sufficient to handle parallel execution and use of multiple trained machine learning models, as well as training of the machine learning models. For example, the memory and processing device may be sufficient to handle parallel execution of 6-15 different machine learning models (e.g., one or more for each of the process chambers 114, 116, 118, and/or load locks of load lock system 120).

In one embodiment, the controller 150 includes an autonomous load lock chamber engine 152. The autonomous load lock chamber engine 152 may be implemented in hardware, firmware, software, or a combination thereof. The autonomous load lock chamber engine 152 may be configured to receive and process measurement data generated by one or more sensors of load lock system 120 during and/or after cycling of substrates through the load lock chambers. The sensor measurements may include temperature measurements, pressure measurements, particle spectrographic measurements, vibration measurements, accelerometer measurements, measurements, voltage measurements, current measurements, resistance measurements, time measurements, optical measurements (e.g., such as optical emission spectrometry measurements and/or reflectometry measurements), position measurements, humidity measurement, part health measurements, and/or other types of measurements. Some example measurements include a chamber pressure (e.g., which may be measured in mTorr), OES spectra measurements for one or more wavelengths or frequencies (e.g., for wavelengths of 3870 nm, 7035 nm, 775 nm, and so on), one or more substrate support/heater temperatures, one or more substrate temperatures, and so on. Some or all of these measurements may be combined to generate a feature vector that is input into a trained machine learning model associated with the controller.

The autonomous load lock chamber engine 152 running on controller 150 may include one or more rules-based engines and/or trained machine learning models for controlling and/or making decisions for one or more load lock chambers. The one or more trained machine learning models may have been trained to receive sensor measurements from and/or associated with a load lock chambers and to make a prediction, classification or determination about the load lock chambers. Each of the trained machine learning models may be associated with a different decision-making process for a load lock chamber in embodiments. Alternatively, one or a few trained machine learning models may be associated with multiple decision-making processes for a load lock chamber in embodiments.

In one embodiment, one or more of the trained machine learning models is a regression model trained using regression. Examples of regression models are regression models trained using linear regression or Gaussian regression. A regression model predicts a value of Y given known values of X variables. The regression model may be trained using regression analysis, which may include interpolation and/or extrapolation. In one embodiment, parameters of the regression model are estimated using least squares. Alternatively, Bayesian linear regression, percentage regression, leas absolute deviations, nonparametric regression, scenario optimization and/or distance metric learning may be performed to train the regression model.

In one embodiment, one or more of the trained machine learning models are decision trees, random forests, support vector machines, or other types of machine learning models.

In one embodiment, one or more of the trained machine learning models is an artificial neural network (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g. classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

One of more of the trained machine learning models may be recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. For example, sensor measurements may continually be taken during a process, and those sets of measurements may be input into the RNN sequentially. Current sensor measurements and prior sensor measurements may affect a current output of the trained machine learning model. One type of RNN that may be used is a long short term memory (LSTM) neural network.

Some trained machine learning models of an autonomous load lock chamber engine 152 use all sensor measurements generated by a load lock chamber. Some trained machine learning models of an autonomous load lock chamber engine 152 use a subset of generated sensor measurements.

Controller 150 may be operatively connected to a server (not shown). The server may be or include a computing device that operates as a factory floor server that interfaces with some or all tools in a fabrication facility. The server may perform training to generate the trained machine learning models, and may send the trained machine learning models to autonomous load lock chamber engine 152 on controller 150. Alternatively, the machine learning models may be trained on controller 150.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

FIGS. 2A-2B illustrate an exemplary embodiment of a load lock system 200. FIG. 2A illustrates a top-down view of an exemplary embodiment of a load lock system (e.g. a load lock system similar to load lock system 120 in FIG. 1); FIG. 2B illustrates a cut-away side-view of an exemplary embodiment of a load lock system (e.g. a load lock system similar to load lock system 120 in FIG. 1). As seen in the FIGS. 2A-2B, load lock system 200 may include two load lock chambers, and include a top 204, a bottom 206, a first (factory) side 208 and a second (transfer chamber) side 210.

The load lock system can include two chambers, an upper load lock chamber 220, and a lower load lock chamber 230. The top chamber can include a substrate 222 and a substrate support device 224. The bottom chamber can include a bottom substrate 232 and a bottom substrate support device 234. Load lock chamber doors 240A and 240B may be associated with the upper load lock chamber 220, and load lock chamber doors 240C and 240D may be associated with the lower load lock chamber 230. Imaging elements 250A-H (note that imaging elements 250E and 250F are unable to be seen in FIGS. 2A-2B) may extend through the top 204 and bottom 206 of the load lock chambers and provide imaging data of a substrate inside the pair of load lock chambers. In some embodiments, these imaging elements may be placed at the corners of a rectangular load lock chamber. However, in some embodiments, the overall load lock chamber shape may not be rectangular, and imaging elements may be placed uniformly around the sidewalls of the load lock chamber.

In some embodiments, the upper and lower load lock chambers 220 and 230 may include substrate aligners at the four corners of the substrate support device to aid in aligning the substrate within the load lock. In one embodiment, the substrate can be aligned by the aligners such that (in the case of a rectangular substrate) the edges of the substrate are parallel to the walls of the respective load lock chamber. In addition to the translational position of the substrate, any physical aspect can be aligned by the aligners, including, but not limited to translational offsets (including z-offsets), rotational offsets, angular offsets of the substrate, or any other irregular offset or irregularity within electronic device manufacturing system that can be remediated by aligners with the load lock chambers. In some embodiments, the center of the substrate can be aligned approximately within 1 mm of the center of the load lock chamber. In some embodiments, the center of the substrate can be aligned approximately within 0.5 mm of the center of the load lock chamber.

In embodiments, where the substrates are not rectangular (or even if they are), a substrate does not have to be aligned such that the edges of the substrate are parallel to the walls of the load lock. In some embodiments, where a substrate is circular, or triangular, or any other shape, regular or irregular, the substrates may be aligned according to any scheme, including aligning the center of the substrate with a desired point in the load lock. One of ordinary skill in the art, having the benefit of this disclosure, will be able to envision and design multiple methods and schemes for aligning the substrate within any load lock chamber.

In some embodiments, the aligners in the load lock chamber may be disposed on or integrated with the support device. In some embodiments they may be alternatively placed in the load lock. One of ordinary skill in the art, having the benefit of this disclosure, will be able to envision and design multiple schemes and locations for placing substrate aligners within (or without) a load lock chamber for aligning the substrate within any load lock chamber.

In some embodiments, the substrate aligners may include an active component, such as a translational or rotational actuator configured to physically move the actuator. In other embodiments, the substrate aligners may be passive, and use gravity to align the substrate, etc.

The above disclosure discloses four substrate aligners placed at each corner of a load lock chamber. However, the load lock chamber may include less, or more substrate aligners and still accomplish a similar goal of aligning a substrate. One of ordinary skill in the art, having the benefit of this disclosure, will be able to envision and design multiple schemes and locations for placing any number of substrate aligners (including more or less than four) within (or without) a load lock chamber and still accomplish a similar goal of aligning the substrate within any load lock chamber.

In some embodiments, load lock chamber doors 240B and 240D may connect a respective upper and lower load lock chambers to a transfer chamber, while load lock chamber doors 240A and 240C may connect respective upper and lower load lock chambers to a factory setting.

Load lock chamber doors 240A-D may serve as a pressure seal for the load lock chambers, isolating the load lock chamber environments from exterior environments when the doors are closed.

As was discussed with respect to FIG. 1, the load lock chamber doors can be slit valve doors. However, in other embodiments, the chamber doors 240A-D may be any kind of industrial door mechanisms designed to isolate a chamber and so transfer a substrate (e.g., flap doors, slit doors, etc.), or any other device from the factor atmosphere into the cluster tool, or vice versa.

FIGS. 2A-2B illustrate a load lock system 200 with two chambers, an upper load lock chamber 220 and a lower load lock chamber 230. Each chamber may be isolated from the other. However, a single load lock chamber system may include one, two, three, or any number of load lock chambers either in a vertical configuration or a horizontal configuration or both. A load lock chamber may also include more than one substrate per chamber. One of ordinary skill in the art, having the benefit of this disclosure, will be able to design a variety of load lock groups including any number of load lock chambers, and any number of substrates within each load lock chamber.

In some embodiments each chamber of the load lock chamber system may have identical dimensions, including identical height, width, and length. In other embodiments, load lock chambers may have varying dimensions, in at least some cases to accommodate different types of lenses of imaging elements.

FIG. 2B illustrates a side-view of an exemplary embodiment of a load lock chamber including substrate support devices 224 and 234. In some embodiments, load lock chamber substrate support devices 224 and 234 can support substrates 222 and 232, respectively. In some embodiments, load lock chamber substrate support devices 224 and 234 can actively, or passively, support the substrates, as will be described in detail further below.

Although FIG. 2B illustrates a load lock chamber substrate support device with a single substrate, a single load lock chamber substrate support device may support one, two, three, or any number of substrates. One of ordinary skill in the art, having the benefit of this disclosure, will be able to design a variety of load lock chamber substrate support devices capable of supporting any number of load lock chamber substrates.

Although FIG. 2B illustrates a load lock chamber with a single substrate support device within a single load lock chamber, a single load lock chamber may include multiple substrate support devices, including one, two, three, or any number of substrate support devices. One of ordinary skill in the art, having the benefit of this disclosure, will be able to design a variety of load lock chambers including multiple substrate support devices.

In some embodiments, load lock chamber substrate support devices 224 and 234 may support substrates 222 and/or 232 passively through the substrates 222 and/or 232 resting on portions of load lock chamber substrate support devices 224 and 234. In some embodiments, load lock chamber substrate support devices 224 and 234 may actively, or mechanically hold, latch, or grab substrates 222 and/or 232. Load lock chamber substrate support devices 224 and 234 may use a latch, actuator, magnets, form fitting portions, clips or any other similar mechanism or combination of mechanisms for actively holding one or more substrates.

In some embodiments, substrates 222 and/or 232 may be a glass substrate. In some embodiments, substrates 222 and/or 232 may be a wafer (e.g., such as a semiconductor wafer). In some embodiments, substrates 222 and/or 232 may be circular, or square, or any other shape suitable for substrate manufacturing.

In some embodiments, substrates 222 and/or 232 may be of a thickness of a range of 0.1 to 1.5 millimeters, or of a range of 0.1 to 1.0 millimeters, or of a range of 0.3 to 1 millimeters.

In some embodiments, substrates 222 and/or 232 may be of one or more materials including borosilicate glass, soda-lime glass, quartz glass, aluminosilicate glass, lead glass, laminated glass, tempered glass, or any one or more glass or other materials commonly used within electronic device manufacturing systems.

In some embodiments, substrates 222 and/or 232 may be of one or more materials including Silicon, Germanium, Gallium Arsenide (GaAs), silicon dioxide (SiO2 or silica), Indium Phosphide (InP), Silicon Germanium (SiGe), Silicon Carbide (SiC), Gallium Nitride (GaN), or any one or more materials commonly used within electronic device manufacturing systems.

In some embodiments, substrates 222 and/or 232 may be formed from one material. In other embodiments, substrates 222 and/or 232 may be formed from a homogenous mixture of materials. In other embodiments, substrates 222 and/or 232 may be made of one or more stacked layers of one or more differing materials. By way of example, substrates 222 and/or 232 may be silicon on insulator (SOI) wafers, where a layer of SiO2 is placed vertically between two insulative silicon layers.

In some embodiments, the substrates 222 and/or 232 may include a deposition area including a deposition pattern on a portion of the substrate. In some embodiments, the top surface area of a substrate may be modified, by various methods of deposition and/or material removal, to form the deposition pattern. Such processes can include, but not limited to physical vapor deposition (PVD), chemical vapor deposition (CVD), atomic layer deposition (ALD), wet etching, dry etching, including reactive ion etching (RIE), deep reactive ion etching (DRIE), and plasma etching. Such processes can further include any other type of commonly used deposition or material removal method commonly used within electronic device manufacturing systems.

In some embodiments, the deposition area of the substrate may be patterned after pre-determined, intended deposition pattern or template. In some embodiments, such a pattern may not extend the full surface of the substrate, and may be offset from the exterior edges of the substrate by a known distance. In some embodiments, the intended deposition pattern may be centered on the substrate. The area between the edges of the deposition area or deposition pattern, and the edges of the substrate, may be referred to as a shadow frame zone, due to being masked by a shadow frame. In some embodiments, this area may be referred to as a buffer area. In either case, the shadow frame zone and the buffer area may be (or may be intended to be) bare substrate with no deposition onto the surface of the substrate.

In some embodiments, the deposition area may be centered on the substrate, and surrounded by a buffer area (shadow frame zone) around the exterior of the substrate. In some embodiments, the buffer area can be an area of the substrate the is bare substrate and has no deposition. In some embodiments, the buffer area may entirely circumscribe the deposition area. In some embodiments, the buffer area may extend inwardly from all four sides of the top surface of the substrate a known distance. In some embodiments, the buffer area may extend inwardly from the exterior of the substrate a range of 0.1 to 100.0 mm, or a range of 0.1 to 50 mm, or a range of 1 to 50 mm, or 1 to 25 mm. Such an area may have a minimum critical width. In some embodiments, each side of the buffer area may remain at, or above, a width of a specified range of between 2-3 mm.

Changes in the buffer area, or shadow frame zone, such as the buffer area being too slim, may be due to, at least, incorrect shadow frame seating, and can result in complications when the substrate is advanced into further process chambers, including, but not limited to, chamber arching (or plasma arching) at the location of buffer areas with a width below the specified critical range. Thus, these areas and sufficient dimensions are critical to maintaining process flow.

As will be discussed in further detail below, the load lock system may verify the buffer area dimensions (or other critical dimensions), and autonomously updated process flow and parameters to remediate incorrect buffer area dimensions (i.e., shadow frame zone dimensions) (or any other critical dimensions associated with the substrate).

In some embodiments, load lock system 200 may include imaging elements 250A-250H, or eight imaging elements at the corners of the load lock chamber group. Imaging elements 250A-250D may extend through the top 204 of the load lock system 200 into the upper load lock chamber 220, so as to capture image data of a substrate (such as substrate 222) within the upper load lock chamber 220. Imaging elements 250E-250H may extend through the bottom 206 of the load lock system 200 into the lower load lock chamber 230, so as to capture image data of a substrate (such as substrate 232) within the lower load lock chamber 230. As will be discussed in further detail below, imaging elements can consist of three subcomponents, such as a camera (e.g. a Seiwa BG160M), a lens (e.g. a Seiwa STV-3018-T5), and an illumination source (e.g. a coaxial illumination source such as a Seiwa SMDA-100 GH).

In some embodiments, the imaging elements may be arranged so to be capable of capturing image data of the substrate edges, or the four corners of the substrate. Imaging elements 250A-D may capture image data looking down onto the top surface of substrate 222 (a silhouette of substrate 222 is seen in FIG. 2A as substrate silhouette 222B, to denote its position within the load lock chamber), while imaging elements 250E-H may capture image data looking up onto the bottom surface of substrate 232.

The position of each imaging element with respect to the load lock chamber and substrate can ensure that each substrate corner, and edges extending from each substrate corner, can be captured by at least one imaging element associated with the load lock chamber.

In some embodiments, and as will be discussed further below, the image processing subsystem may combine the image data associated with a single substrate, so as to present a single image of a single substrate profile to a user. In certain embodiments, the field of view (FOV) of each imaging element may be large enough that although the imaging elements are placed at the corners of the load lock chamber, a holistic image or image profile of the substrate can be formed by combining the image data from each imaging element. In certain embodiments, a substrate profile may simply be the profile, or contour lines of the substrate within the image, when compared to the background within the load lock chamber.

In some embodiments, the interior of the load lock chamber may include a light absorbing material, such as Acktar, to aid in identification and differentiation of the substrate profile from the image data background from within the image data.

While FIGS. 2A-2B illustrate eight imaging elements positioned at the four corners of a load lock chamber system with two chambers, in some embodiments, more (or less) than eight imaging elements may be associated a load lock chamber group of any number of chambers. In some embodiments imaging elements may be included to further image the edges (including the entire span of every edge, or even the entirety of the substrate surface) of a substrate and be located between any of the corners.

In some embodiments, imaging elements may be positioned more center with respect to edges of a load lock chamber, and capture image data of a substrate surface more central with respect to the substrate, or distant from the substrate edges. In some embodiments, the imaging elements may be positioned in a graph or an array so as to capture more comprehensive data. In other embodiments, the imaging elements may be positioned more linearly. In other embodiments (employed, for example, to save costs), the imaging elements may only be placed at locations with line-of-sight to part or tool critical dimensions and critical aspects. In one, non-limiting, example, more than two imaging elements may be positioned along first side 208, including, two, three, or any number of additional imaging elements in the space denoted between imaging element 250A and 250D.

In some embodiments, the imaging elements associated with the bottom chamber may be placed similarly to the upper chamber, or in some embodiments placed differently.

While FIGS. 2A-2B illustrate eight imaging elements positioned at the four corners of a load lock chamber system with two chambers, each chamber comprising one substrate, one of ordinary skill in the art, having the benefit of this disclosure, will be able to design a load lock chamber system with two or more chambers, where each chamber includes any number of substrates, and the commensurate imaging elements to capture image data of the substrates.

In some embodiments, one or more imaging elements of the system may capture images of the substrate after the substrate has been placed on the substrate support device within the load lock chamber. Such images may be static and limited to the imaging element's current field of view (FOV).

In some embodiments, one or more imaging elements of the load lock chamber may capture images of the substrate as it is in motion, while it being placed on, or removed from, the substrate support device within the load lock chamber. In some embodiments, this may grant a single imaging element an enhanced view of the substrate, for example, imaging element 250D may capture image data of a substrate as it is being transferred into the load lock chamber through first side 208. Thus, as the substrate is translated into the load lock chamber, imaging element 250D may capture image data of an entire edge length of the substrate. Imaging element 250A may function similarly, and imaging elements 250B and 250C may function similarly as a substrate is being transferred out, or in, of side 210. The imaging elements associated with the bottom chamber may act similarly as well.

In some embodiments, multiple additional imaging elements may be placed along first side 208 and second side 210 of the load lock chamber (top and bottom chambers), so as to be able to capture more comprehensive image data, including data associated with the center of the substrate, as the substrate is being transferred into, or out of the load lock chamber from either side.

In some embodiments, the image data captured by imaging elements associated with the load lock chamber may be used to detect errors, or inconsistencies associated with the substrate. In some cases, detected inconsistencies can be traced back to specific erroneous processes, in some cases, inconsistencies may indicate part maintenance is required.

In some embodiments, one or more manufacturing processes associated with a cluster tool including the load lock chamber, or electronic device manufacturing system at large may introduce one or more inconsistencies, or defects, into the substrate or associated substrate handling system. In some embodiments, inconsistencies can be of the form of one or more defects of the substrate and/or substrate profile and can be captured by imaging elements. In some embodiments, inconsistencies can be of the form of an error in placement, or misplacement, of a substrate with respect to the load lock chamber and can also be captured by imaging elements.

Inconsistencies can include substrate defects including substrate body-level defects (e.g. scratches, pitting, roughness, cracking, bubbling, etc.), substrate deposition-level defects (e.g. deposition pattern translational offsets, deposition pattern rotational offsets, leakage or nonconformity or non-linearity, contamination, etc.), substrate dimensional defects (e.g. warping, bowing, cracking, breaking, thickness non-uniformity, under-sizing, thinning, over-sizing, etc.), material composition defects, contamination defects (e.g., impurities in the material composition), or any other defects commonly associated with substrates of electronic device manufacturing systems.

In some embodiments, such a substrate body-level defect may be a break, or crack extending through the substrate. Such a break or crack may only affect the surface of a substrate. Such a break or crack may extend the entire thickness of the substrate. Such a break or crack may originate from any point on or within the substrate and extended to any other point on or within the substrate, including the edges or ends of the substrate.

Such a break or crack in the substrate may be of a width ranging from 0.1 mm to 1 mm, from 10 μm to 10 mm, or from 1 μm to 10 mm.

Such a break or crack in the substrate may be of a depth or thickness ranging from 5% to 10% of the substrate thickness, from 5% to 30% of the substrate thickness, from 5% to 60% of the substrate thickness, or from 5% to 100% of the substrate thickness.

In some embodiments, such a substrate body-level defect may be gap, or a chip, along an exterior surface or edge or corner of the substrate. Such a chip may be of any shape, figure, or size. Such a chip may affect any length of one, or multiple, dimensions of the substrate ranging from 1 mm to 1 mm, from 10 μm to 10 mm, or from 1 μm to 10 mm.

In some embodiments, such a defect may be a deposition pattern defect, including a placement error of a pattern, or deposition, on the surface of the substrate. In some embodiments, a deposition placement error can be of any kind, including a translational misplacement, where the deposition center and/or the entire real deposition pattern is offset from an intended placement of the deposition center and/or the entire intended deposition pattern placement on the surface of the substrate. Such an offset can be a translational offset by some amount, a rotational offset by some amount, or a combination of the two. In some embodiments, these types of deposition placement errors can be measured by looking at the deposition area with respect to the substrate, or looking at edges of the deposition area corresponding with edges of the substrate. In some embodiments, these type of deposition placement errors may also be identified by analyzing changes or offsets in the buffer area (shadow frame zone). For example, if the whole deposition area rests at an angle that is offset from the intended placement angle of the deposition area, and/or offset with respect to the edges of the substrate. The buffer area will be affected by increasing in some portions, and decreasing in others.

In some embodiments, a deposition pattern defect can include a type of defect where deposition has spread to areas not intended for deposition or where deposition has spread according to a nonconforming and/or non-linear image profile. In some cases, such a defect, or leakage, may resemble a blob, or patch, protruding from the deposition area into the buffer area or shadow frame zone. In some cases, this non-linear and nonconforming profile such as a blob or path, can be referred to as a leakage area. In some embodiments, leakage may alter or produce errors in the deposition pattern, separate any errors of misplacement, alignment, or calibration of a deposition pattern on a substrate.

In some embodiments, such a deposition pattern defect (e.g. leakage) may affect the buffer areas surrounding the exterior edge of a substrate and deposition area. In some embodiments, such a buffer area may be reduced, or enlarged, due to a deposition placement error.

These changes in the buffer area, or shadow frame zone, such as the buffer area being too slim, can be indicative of complications that will arise in further process chambers, including, but not limited to, chamber arching at the location of slim buffer areas.

In some embodiments, inconsistencies can be of the form of substrate placement, or misplacement, due to errors and offsets in positioning of a substrate. A substrate placement error can occur in the load lock chamber, on the transfer robot end effector, or in any of the substrate processing chambers. A substrate placement error can be of any kind, including a translational misplacement, where the substrate center is offset from the desired substrate center by some amount, or a rotational misplacement, where the substrate may rest at an angle that is offset from the desired angle of a properly placed substrate.

As will be discussed in further detail below with respect to FIG. 3, the load lock system and/or image processing subsystem may detect inconsistencies (e.g., placement errors or offsets in the substrate or in the deposition area placement). Furthermore, the load lock system and/or imaging processing subsystem may autonomously engage subsystems and/or mechanisms to remediate any detected placement errors. As the image processing system verifies and determines the dimensions, contours, errors, and/or offsets of the buffer area, deposition area, and/or substrate, the image processing subsystem may send data and/or process updates to remedy one or more process(es) associated with a defect.

By way of a non-limiting example, when detecting the dimensions of the buffer area, and offsets or errors in the placement of the deposition area, associated data (e.g., measurements and angles, or remediation measures), may be sent to the process chamber(s) and associated transfer mechanism(s) associated with placement of the shadow mask and/or deposition area. In the specific case of a placement error discussed above, and in a non-limiting example, the substrate position may be adjusted during insertion and removal within the chamber where the deposition area is added to remediate the detected errors.

By way of a non-limiting example, and in respect to the above example, the remediations for the detected errors in substrate position may be effected by the substrate transfer mechanism (e.g., the transfer robot). In other embodiments, more fine-tuned mechanisms may effect the remediations for substrate positioning (e.g. the substrate aligners discussed with respect to the disclosure with respect to FIGS. 2A and 2B).

One of ordinary skill in the art, having the benefit of this disclosure will be able to envision and design multiple pathways and mechanism to calculate and transfer remediation data and/or system remediations (i.e. updates and/or calibrations) themselves from the errors and offsets detected by the image processing system to the associated processes and subsystems.

Furthermore, one of ordinary skill in the art, having the benefit of this disclosure will be able to envision and design one or more acute points within the associated processes and systems (e.g., actuators, aligners, chuck-movement or other classes of acute points within a system) to effect the remediation (i.e. corrections) and eliminate the detected offsets and errors from future substrate processing. In some embodiments, in order to identify these inconsistencies, or errors, captured by the imaging elements, the load lock chamber group system may communicate image data from imaging elements to an image processing subsystem (as seen in FIG. 3) to process image data of a substrate and extract dimension-level characteristics, including inconsistencies and errors, of a substrate associated with the image data.

FIG. 3 illustrates an exemplary embodiment of an image capture and processing subsystem. In some embodiments, the imaging capture and processing subsystem 300 can include a master system 302, an imaging subsystem 320, and lighting subsystem 350, and an image processing subsystem 340. The imaging subsystem 320 and lighting subsystem 350 may each be associated with a load lock chamber 370. In some embodiments, the image capture and processing subsystem 300 can be used to identify inconsistencies within a substrate within a load lock chamber 370 based off the image data communicated from the imaging subsystem 320 (and imaging elements 330A-H) working alongside the lighting subsystem 350 (and coaxial LEDs 360A-H), to the image processing subsystem 340.

In some embodiments, lighting elements 360A-H may be one, or any combination of include LEDs, or ring lights. In some embodiments, lighting elements may be coaxially aligned with a respective imaging element. In other cases, lighting element may be arranged peripherally with an imaging elements.

Image capture and processing subsystem 300 makes use of a master subsystem, an imaging subsystem, an image processing subsystem, and a lighting subsystem. In the embodiment see in FIG. 3, the imaging subsystem comprises eight imaging elements, and eight lighting elements, each associated with one load lock chamber 370. In other embodiments, more (or less) than eight imaging elements and eight lighting elements may be used for one load lock chamber. In some embodiments, the imaging and lighting subsystems may be associated with, and capture data from, more than one load lock chamber, or any number of load lock chambers, with any number of imaging and lighting elements. One of ordinary skill in the art, having the benefit of this disclosure will be able to design such a system including multiple load lock chambers, substrates, and imaging and lighting elements in various configurations.

In some embodiments, master system 302 may be connected to imaging subsystem 320, image processing subsystem 340, and lighting subsystem 350 via a number of communications conduits and communications protocols (in some embodiments, master system 302 may be the controller 150 as seen and described in FIG. 1). In some embodiments, the imaging subsystem, image processing subsystem, and lighting subsystems may be connected to a master system via an Ethernet cable and communicate with a Seiwa Lan protocol.

In some embodiments, the imaging subsystem may communicate with imaging elements and the image processing subsystem via ethernet cables and a generic interface for cameras, e.g. GigE Vision, USB3 Vision, CoaXpress, Camera Link HS, Camera Link, or any other commonly used interface and communications systems used for imaging elements within an electronic device manufacturing system.

In some embodiments, the image processing subsystem can include use of an image processing software package (e.g. an OpenCV image processing package or similar), an operating system (e.g. CentOS operating system or similar), and a UI software development package (e.g., a PySide software package or similar), or any other kind of image processing software package commonly used in image processing systems.

In some embodiments, captured image data from the imaging elements (as seen by imaging elements 330A-H in FIG. 3), may be communicated to an image processing subsystem 340 including an industrial PC 322 where a user may interact with a user interface (UI) 326 via a monitor, mouse, and keyboard to identify and characterize inconsistencies and/or errors within image data. In some embodiments, the image processing subsystem 340 may require user inputs to identify inconsistencies or defects within the captured image data. In other embodiments, the image processing subsystem may autonomously identify inconsistencies and defects.

In some embodiments, the UI may present an image or combined image data collected from the imaging elements to a user of the UI. In some embodiments, the presented image data or combined image data can comprise an image profile (i.e. the contours and areas of image objects when presented from a single perspective, or a combination of perspectives, of the image data) of a substrate or portion of a substrate in a substrate chamber. In some embodiments, via the UI, a user may be able to visually identify the deposition area of a substrate, the buffer area, the contours of the deposition area, and the contours of the substrate against a background of the load lock chamber, within the image. In some embodiments, the background of the load lock chamber may include a contrasting material, such that the contours of the substrate are clearly visible against the background. In some embodiments, the contrasting material can be a light absorbing material, such as Acktar.

In some embodiments, during setup of the image processing subsystem 340, and the UI 326, the image processing subsystem 340 may be calibrated such that pixels of the UI correspond to real-time measurements, such as mm, or centimeters. In some embodiments, when an image data of a substrate profile is presented to the user via the image processing subsystem UI, distances and/or dimensions of the image may be denoted via pixels, and/or metric dimensions. In some embodiments, a grid system may be shown to the user via the UI, denoting pixels, and/or metric dimensions.

In some embodiments, high refresh rates of the imaging elements can produce a set of similar captured image data. In some embodiments, such a set of image data may be averaged by the image processing subsystem, and the averaged image data may be advanced for further processing. In some embodiments, such an average may produce a profile, or image data, that is more accurate, or more consistent with the real profile of the real objects associated with the image data.

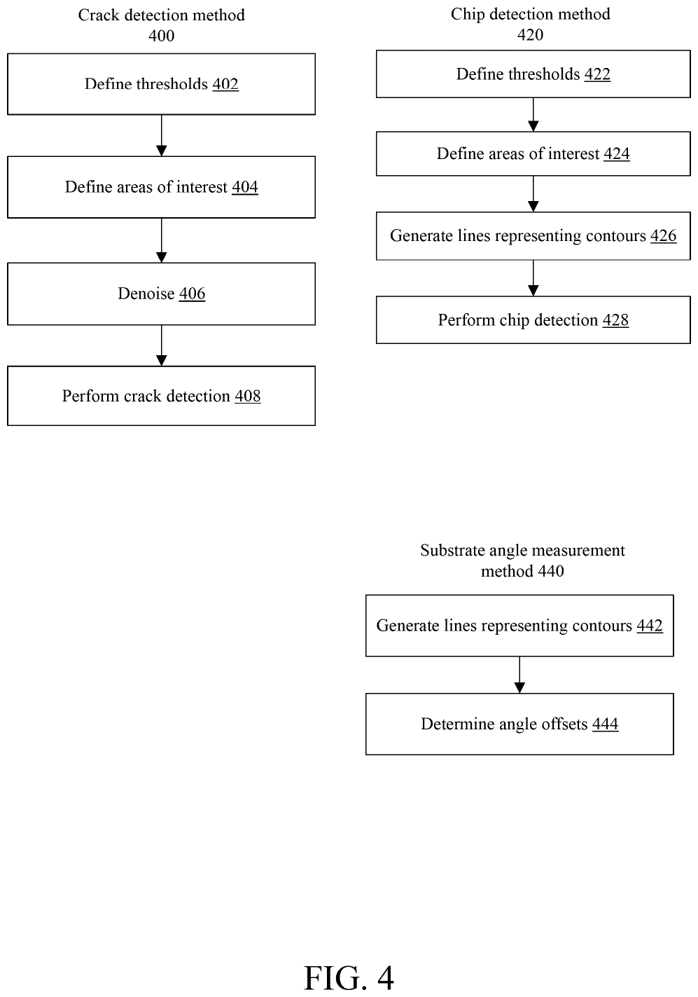

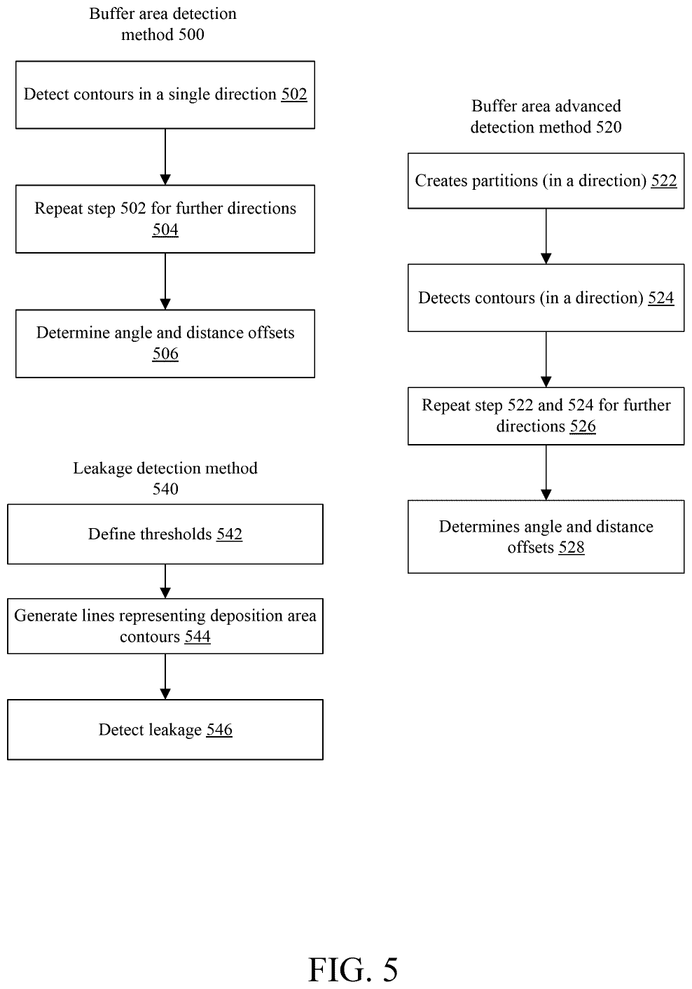

The following features and methods, including denoting areas of interest, image denoising, image filtering, and automated edge detection, will be described below. These features will be made of further use in the image processing methods described in FIGS. 4-5. Although these features and methods may be described with further specificity with respect to FIGS. 4-5, one should bear in mind that alternative embodiments may use variations of those features and methods, including those described below. For example a method may be described with respect to FIGS. 4-5 that makes use of an edge detection algorithm—in specific, a Canny edge detection algorithm. However, the reader should bear in mind that this Canny edge detection algorithm can be substituted for any similar algorithm or technique, including the features, methods, and techniques described immediately below.

In some embodiments, the subsystem may receive selected areas of interest (e.g. from a user) for an image data presented via the UI, for the image processing software to investigate further, or analyze further via a specified algorithm. In some embodiments, the image processing subsystem may require a user to denote an area of interest via drawing of a shape overlaying the presentation of image data of the profile of a substrate. In some embodiments, the subsystem may receive (e.g. from a user) a bounding data, including a shape, such as a rectangle, a circle, an ellipse, or any other bounding shape to denote an area of interest overlaying the presentation of image data of the profile of a substrate. In other embodiments, alternate methods of delineating an area, including input of coordinates to denote an area of interest overlaying the presentation of image data of the profile of a substrate, may be used.

In some embodiments, the UI may render the dimensions in pixels and/or metric measuring system, of the area of interest, as the user is inputting the bounding data.

In some embodiments, more than one area of interest may be received simultaneously.

In some embodiments, areas of non-interest can be denoted (e.g. by a user of the interface) in a similar manner. Such areas may be marked and excluded from any further analysis by the imaging processing subsystem.

In some embodiments, the image processing subsystem can employ image denoising using one or more filters. In some embodiments, these filters can include spatial methods, including mean filtering, median filtering, gaussian smoothing, or any similar spatial filtering method. In some cases the filter may be transform based, including a wavelet transform, or a Fourier transform, binarization, or any other kind of similar transform. In other embodiments, a machine learning model, such as one or more CNNs or a GANs model, or any other similar model may be used to denoise an image. One of ordinary skill in the art will recognize that these algorithms are part of a rapidly developing field of computer vision, and that this list is non-comprehensive, and may be updated and altered to incorporate further state-of-the-art techniques for image denoising.

In some embodiments, the image processing subsystem can employ edge and corner detection using one or more algorithms, including but not limited to a Sobel operator, a Prewitt operator, a Canny operator, an Otsu's algorithm operator, or other similar algorithms or any combination of such algorithms. In some embodiments, any one of these algorithms may find multiple lines associated with a real edge or real line of the image. In such cases, an average of the produced lines may be taken, and the average line data may be used to reflect the real edge or real line present in the image. One of ordinary skill in the art will recognize that these algorithms are part of a rapidly developing field of computer vision, and that this list is non-comprehensive, and may be updated and altered to incorporate further state-of-the-art techniques for edge detection.

Many of these computing elements and algorithms will be described according to their applications with respect to the methods of FIG. 4 and FIG. 5.

FIG. 4 illustrates an exemplary method for detecting a crack in a substrate, an exemplary method for detecting a chip in a substrate, and an exemplary method for measuring the angle of a substrate within a load lock chamber.

According to some embodiments, the image processing subsystem may implement a crack detection method such as method 400 to detect a crack or break in a substrate.

At step 402 of crack detection method 400, a size threshold associated with the pixel size of the crack that will be searched for by the computer implement portions of method 400 is defined. Such a size threshold may be associated with the width and/or length of the crack that will be searched for. In one embodiment, the subsystem receives an indication of the size threshold as an input (e.g. from a user). In another embodiment, the subsystem is preconfigured with a default size threshold.

At step 404 of crack detection method 400, in some embodiments, the image processing system can present a UI to a user including an image data including a profile of at least a portion of a substrate. The system can provide the image data to a user. In some embodiments, the subsystem receives one or more region boundary denoting one or more areas of interest from a user. The one or more area of interest can represent bounded areas containing a crack or other non-conformities within the presented image data of a substrate for the image processing subsystem to further analyze.

At step 406 of crack detection method 400, the image processing subsystem may record the area of interest denoted by the user, in some cases the pixel boundaries of the area of interest can be stored by the image processing subsystem.

At step 408 of crack detection method 400, in some embodiments, the image processing subsystem may apply a filter to denoise the denoted area of interest. In some embodiments, this may be done by binarizing the image data (e.g. individual pixels) within the area of interest. In some embodiments, the binarized image data may be presented to a user.

At step 410 of crack detection method 400, an edge detection algorithm may be used to identify cracks and produce a data reflective of the location of the crack within the image data. In some embodiments, the edge detection algorithm may use a Canny operator.

In some embodiments, the image processing system can further render, via the UI to the user, the size and location of the crack with respect to the image data, either in pixels or in metric units, either in binarized form, or original form.

In some embodiments, the image processing subsystem may further output an error message to a user indicating that a crack was detected, along with characterization data of the crack, including, but not limited to the length, width, location, or any other data characterizing the detected crack.

According to some embodiments, the image processing subsystem may implement a chip detection method such as method 420 to detect a chip in a substrate edge.

At step 422 of chip detection method 420, a first, size threshold value associated with the size of the chip that will be searched for by the computer implement portions of method 420 may be defined. A second, distance threshold value for pixel offsets, a similar parameter to the first threshold value, but one that denotes the distance of the chip feature, in pixels, from a detected substrate edge may be defined. In some embodiments, the subsystem receives an indication of the one or both threshold values as an input (e.g. from a user). In another embodiment, the subsystem is preconfigured with a default size threshold for one or both thresholds.

At step 424 of chip detection method 420, in some embodiments, the image processing subsystem can present a UI to the user of the subsystem including an image data of a substrate profile, including one or more contours of a substrate. In some embodiments, the UI can present a corner profile of the image data of a rectangular substrate to a user. The user can visually inspect the presented image including the contours of the substrate, for chips and/or nonconformities in the substrate edge. In some embodiments, the subsystem receives one or more region boundaries denoting one or more areas of interest (e.g. from a user). The one or more areas of interest can represent bounded areas from within the presented image data of a substrate profile for the image processing system to further analyze.

In some embodiments, in step 424, the subsystem will identify the substrate contours from within the substrate profile presented by the UI, by receiving data indicative of one or more areas of interest of the substrate profile denoting the substrate contours. In alternative embodiments, the image processing subsystem may automatically identify the substrate contours of the image or substrate profile.

At step 426 of chip detection method 420, in some embodiments, the image processing subsystem may employ an edge detection algorithm (e.g. a Canny operator) to find the contours and generate a line denoting edges of a substrate within the denoted areas of interest.

In some embodiments, the edge detection algorithm can output a line, comprising pixel data, denoting a contour of a substrate within the area of interest. The representative line and denoted contour may include any chips or nonconformities in the substrate edge, as well as any other variations that may be within the substrate edge profile.

At step 428 of chip detection method 420, the image processing subsystem may mask out uniform substrate contours as well as contours of chips and nonconformities of negligible size (e.g. chips and nonconformities that fail to meet the two thresholds defined in step 422 of method 420). Thus step 428 may find chips and nonconformities in the substrate contours by first comparing the relative size of a nonconformity contour against a size threshold; and second, by comparing the pixel distances between a nonconformity's contour (e.g. a chip contour) and a substrate edge against a pre-defined threshold (e.g. by comparing the pixel distances between the chip contours and the nearest uniform substrate contours against a threshold) (i.e. comparing the distance between a chip and the substrate edge against a threshold).

Thus, the image processing subsystem may compare the size of the nonconformity's (e.g. chip's) contour, and the nonconformity's (e.g. chip's) distance away from a substrate edge to determine whether to mask out, or record, a chip or nonconformity. For chips and nonconformities that exceed the thresholds, in some embodiments, the image processing subsystem may characterize and store relative sizes and locations.

In some embodiments, the image processing system can further render, via the UI to the user, the size and location of the detected nonconformities (including chips in the substrate) with respect to the presented image data, either in pixels or in metric units. In some embodiments, the imaging subsystem may further output an error message indicating that a chip and/or contour nonconformity was detected. In some embodiments, associated characteristic data of the nonconformity such as size, distance from an edge, and/or location can be output together with the error message.

According to some embodiments, the image processing subsystem may implement a method 440 for detecting the angles of the substrate edges, or edge contours within the substrate image data.

At step 442 of method 440, in some embodiments, the image processing subsystem can autonomously identify the edges of a substrate against a load lock chamber background through use of an edge detection algorithm (e.g. in some instances, the Hough-line transform from the OpenCV software package may be used to autonomously detect the substrate contour within the substrate image data), and represent it with one or more lines comprising pixel data.

In some embodiments, the edge detection algorithm may output multiple lines reflective of a single substrate contour. In such cases, the average of the multiple output lines can be taken to arrive at a single line representative of the substrate contour.

At step 444 of method 440, in some embodiments, the image processing subsystem can further identify the angle of the representative line when compared to a horizontal (or vertical) line, to determine the real angle offset of an edge of a substrate. Such a procedure can be repeated for further directions (including the horizontal, or any direction) and further edges of the substrate.

In some embodiments, the image processing subsystem can further render, via the UI to the user, both the reference horizontal and vertical lines, together with the generated lines reflective of a substrate edge. The imaging processing subsystem can further output and render the offset angles between the reference and generated lines, if there are any.

In some embodiments, the image processing subsystem can further determine and/or render the distance offset between the reference lines, and generated lines.

In some embodiments, the reference lines may be indicative, or parallel, with the walls of the load lock chamber, or an axis of the substrate support device.

In certain embodiments, an angle offset between the lines can be used to determine whether a substrate has been properly placed on a substrate support device of the load lock chamber. In some embodiments, the imaging subsystem may further output a message indicating that an angle offset has exceeded a certain acceptable level or threshold.

In certain embodiments, a distance offset between the lines can be used to determine whether a substrate has been properly placed on a substrate support device of the load lock chamber. In some embodiments, the imaging subsystem may further output a message indicating that a distance offset has exceeded (or is beneath) a certain acceptable level or threshold. The subsystem may also output, characterization data including distance and/or angle offsets, etc. within the error message as well.

FIG. 5 illustrates an exemplary method for detecting a buffer area, an exemplary method for detecting a buffer area in an advanced manner, and an exemplary method for detecting leakage in the buffer area.

According to some embodiments, the image processing subsystem may implement a method 500 to identify the dimensions of a buffer area (shadow frame zone) associated with a substrate (i.e. the area between the exterior edges of the substrate and a deposition edges of a substrate).

At step 502 of method 500, the image processing subsystem can autonomously identify the contours of a substrate and the contours of the deposition area (denoting and circumscribing the buffer area) simultaneously through use of an edge detection algorithm e.g. in some instances, a Hough-line transform from the OpenCV software package may be used to autonomously detect the contour lines of a substrate and/or deposition area within the image data presenting the substrate profile, as captured by the imaging elements. In some embodiments, such an algorithm may generate multiple lines representing only one contour that is visible in the image. In such a case, the average of the multiple lines may be taken to arrive at a single output line for presentation.

In step 502, in some embodiments, lines representative of contours may be generated with respect to a first direction (e.g. only the horizontally facing edge contours may be detected, and only lines representing these contours may be generated).

At step 504 of method 500, step 502 can be repeated any number of times for further directions and/or dimensions of the presented image data (e.g. step 502 may first generate lines representative of the vertical contours of the substrate and deposition area, after which, step 504 may repeat the processes of step 502 in the horizontal direction and generate lines representative of the horizontal contours of the substrate and deposition area).

In step 506, the generated lines can be presented to the user. In some embodiments, the image processing subsystem can further render, via the UI to the user, both the generated lines representing the substrate contours, and the generated lines representing the substrate area contours. The imaging processing subsystem can further determine and render the offset angles between the lines representing the deposition area contours, and the lines representing the substrate contours, if there are any.

In certain embodiments, such angle offsets can be used to determine whether a deposition pattern has been properly placed on a substrate. In some embodiments, the imaging subsystem may determine that the deposition pattern has been improperly placed, and output an error message to a user indicating such. The subsystem may further include in the error message, data characterizing the improper placement of the deposition pattern, including but not limited to rotational offset, translational offsets, or any other nonconformities.

In step 506, in some embodiments, the image processing subsystem may further calculate the distance between all points of the line reflecting the deposition area contours, and the line representing the substrate contours. This distance denotes the width of a buffer area surrounding the deposition area. Should the buffer area width fall below a buffer width threshold value, this can denote a risk for chamber arching. The UI can present a message or indication to a user if such a condition of the buffer area width is found. In some embodiments, the buffer width threshold value can be set at a range of 2-3 mm.

In some embodiments, the substrate material composition and deposition area composition may present image data including contours and areas that make it difficult for a computer edge detection algorithm to autonomously generate lines reflective of contours, even from indicated areas of interest, if these areas are too large.

In such cases, the subsystem may identify contours using a variation of method 500, by analyzing smaller partitions of the image data (or area of interest) piecewise. An edge detection algorithm may identify contours within each smaller partition, and then combine the identified contours to output a single line including data representative of the contours of the larger image data.

According to some embodiments, the image processing subsystem may implement a method 520 to detect a buffer area (shadow frame zone) of the substrate in an advanced method.

At step 522 of method 520, a number of directional partitions can be defined, and the image processing subsystem can divide the image into that number of partitions in a first direction. In one embodiment, the subsystem receives an indication of the number of partitions as an input (e.g. from a user). In another embodiment, the subsystem is preconfigured with a default number of partitions. For example, in step 522, if the subsystem has received (e.g. from a user) a number of directional partitions of ten, then the subsystem may divide the image in a first direction (such as horizontally) into ten partitions, or slices, of the total image data. The number of directional partitions may be any reasonable number limited by the edge detection method that will be used, and the total number of pixels in a single dimension of the image data presented.

In step 524, in some embodiments, the image processing subsystem can autonomously identify the contours of a substrate and the contours of the deposition area (denoting and circumscribing the buffer area) and generate a line representative of the contours, within each image partition, or slice. In some embodiments, the image processing subsystem may use a line detection algorithm e.g. a Hough-line transform from the OpenCV software package may be used to autonomously detect the contours of a substrate and/or deposition area within the image data, and generate a line representative of each contour. In some embodiments, such an algorithm may generate multiple lines corresponding to only one contour that is visible in the image. In such a case, the average of the multiple lines may be taken to arrive at a single output line for representing the contour.

In step 524, in some embodiments, the generated lines representative of contours within the image partitions can then be combined to form one line, representative of object contours in the complete image data and the presented surface profile.

At step 526 of method 520, steps 522 and 524 can be repeated for further dimension e.g. first, vertical lines representing the vertical contours of the substrate and deposition area within the image data can be generated via steps 522 and 524, and after, horizontal lines representing the vertical contours of the substrate and deposition area can be generated via steps 522 and 524. In some embodiments, this can be done vice-versa, or repeated multiple times, for multiple directions.

In some embodiments, the image processing subsystem can further render, via the UI to the user, both the generated lines representing the substrate contours, and the generated lines representing the deposition area contours. The imaging processing subsystem can further output and render the offset angles between the lines, if there are any.

In certain embodiments, such angle offsets can be used to determine whether a deposition pattern has been properly placed on a substrate. In some embodiments, the imaging subsystem may determine that the deposition pattern has been improperly placed, and output an error message to a user indicating such. The subsystem may further output, either in the error message or separately, characterization data reflective of the improper placement, including offset angles, distances, or any other kind of characterization data associated with the improper placement.

In step 506, in some embodiments, the image processing subsystem may further calculate the distance between all points of the line reflecting the deposition area contours, and the line representing the substrate contours. This distance denotes the width of a buffer area surrounding the deposition area. Should the buffer area width fall below a buffer width threshold value, this can denote a risk for chamber arching. The UI can present a message or indication to a user if such a condition of the buffer area width is found. Such a message can include characterization data reflective of this condition, including offset angles, distances, or any other kind of characterization data associated with the condition. In some embodiments, the buffer width threshold value can be set at a range of 2-3 mm.

In some embodiments, the substrate deposition area can include a nonconformity such as an irregular blotch or patch of deposition protruding from the deposition area into the buffer area. In some embodiments, a nonconformity in the deposition area dimensions, such a blotch, can indicate a patch of deposited material that has spread into the buffer area. Such a nonconformity can be referred to as a leakage point, or simply “leaking.”

According to some embodiments, the image processing subsystem may implement a method 540 to identify a nonconformity (e.g. leakage) of the deposition area.

At step 542 of leakage detection method 540, a first, size threshold value associated with the size of the nonconformity (e.g. leakage) that will be searched for by the computer implement portions of method 540 may be defined. A second, distance threshold value for nonconformity (e.g. leakage), pixel offsets, a similar parameter to the first threshold value, but one that denotes the distance of the nonconformity (e.g. leakage), feature, in pixels, from a detected deposition area edge can be defined. In some embodiments, the subsystem receives an indication of the one or both threshold values as an input (e.g. from a user). In another embodiment, the subsystem is preconfigured with a default size threshold for one or both thresholds.

At step 544, in some embodiments, the image processing subsystem can present a UI to the user including an image data of a profile including one or more contours of a deposition area. In some embodiments, the UI can present a corner profile of the image data of a rectangular deposition area to a user. The user can visually inspect the presented image including the contours of the deposition area, for leakage and/or nonconformities in the deposition area edge. In some embodiments, the subsystem receives one or more region boundaries denoting one or more areas of interest (e.g. from a user). The one or more areas of interest can represent bounded areas within the presented image data of a deposition area profile for the image processing system to further analyze.

In some embodiments, in step 544, the subsystem will identify the one or more contours of the deposition area edges as areas of interest from within the contours presented by the UI. In alternative embodiments, the image processing subsystem may automatically identify the deposition area contours from the image or substrate profile.

At step 544 of leakage (e.g. nonconformity) detection method 540, in some embodiments, the image processing subsystem may employ an edge detection algorithm (e.g. a Canny operator) to find the contours and generate a line denoting edges of a deposition area within the denoted areas of interest.

In some embodiments, the edge detection algorithm can output a line, comprising pixel data, representing a contour of a deposition area within the area of interest. The line and the represented contour may include any leakage or nonconformities in the deposition area edge, as well as any other nonconformities that may be within the deposition area edge contour.

At step 546 of chip detection method 540, the image processing subsystem may mask out uniform deposition area contours as well as contours of nonconformities of negligible size (e.g. leakage and nonconformities that fail to meet the threshold set defined in step 542). Thus step 546 may find leakages and nonconformities in the deposition area contours by first comparing the relative size of a nonconformity (or leakage) contour against a first threshold; and second, by comparing the pixel distances between a leakage (or nonconformity) and a deposition area edge against a second, pre-defined threshold e.g. by comparing the pixel distances between the leakage (or nonconformity) contours and the nearest uniform substrate contours (i.e. the pixel distance between a nonconformity or leakage and a deposition area edge) against a threshold.

Thus, the image processing subsystem may compare the size of the nonconforming element (e.g. a leakage) contour, and its distance away from a deposition area edge to determine whether to mask out, or record, a leakage or nonconformity. For leakages and nonconformities that exceed the thresholds, in some embodiments, the image processing subsystem may characterize and store the relative sizes and locations.

In some embodiments, the image processing system can further render, via the UI to the user, the size and location of the leakage or contour nonconformities with respect to the presented image data, either in pixels or in metric units. In some embodiments, the imaging subsystem may further output an error message indicating that a leakage and/or contour nonconformity was detected. In some embodiments, associated characteristic data of the nonconformities and/or leakages such as size, distance from a deposition area edge, and/or location can be output together with the error message.

In some embodiments, a first profile of an unprocessed substrate can be recorded via the image data as it enters the load lock chamber, and the first profile can be compared to a second profile of the substrate after is has been processed. The comparison of the first and second substrate profile and any introduced defects between the substrate profiles, can be associated with any one or more of the processes and/or chambers that were applied to the substrate in between the generation of the first and second substrate profiles and associated image data. In such a way, image data from the load lock chamber of a substrate can be used to identify degradation, or error introductions, in any of the process chambers.

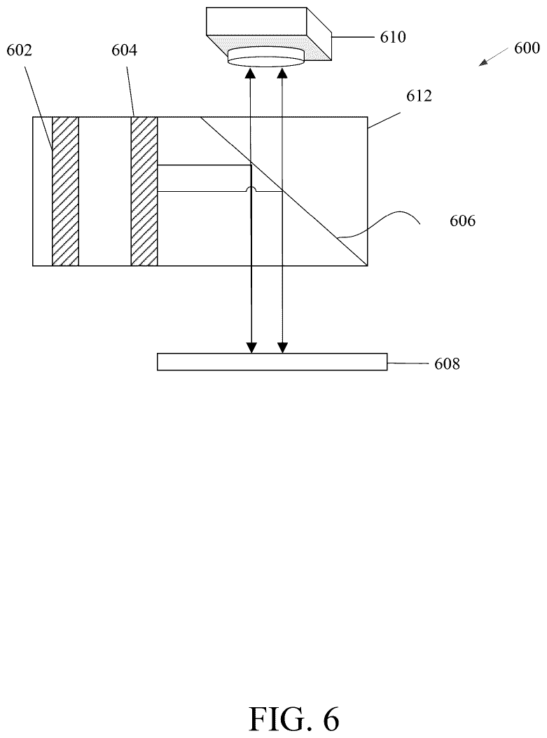

FIG. 6 illustrates an exemplary embodiment of an imaging element. In some embodiments, imaging element 600 may include a lighting element 602, a diffuser 604, a beam splitter 606, an inspected material 608, a sensing element 610, and a housing 612.

In some embodiments, a lighting element 602 may emit light that passes through diffuser 604. Light from diffuser 604 may pass through the beam splitter 606 and be directed towards the inspected material 608. In some embodiments, light from the beam splitter may reflect from the inspected material and may return to the beam splitter, pass through the beam splitter, and continue to sensing element 610. Sensing element 610 may include a lens and an image sensor (not shown in the figure). The captured image data by sensing element 610 may then be communicated to the image capture and processing subsystem at large for further processing.

In some embodiments, the lighting element 602 may be arranging coaxially, as in FIG. 6. In other embodiments, the lighting element may be arranged peripheral to the sensing element. In some embodiments, the light source may be positioned behind the sensing element (backlit), in an off-axis configuration, or any other type of configuration commonly used in electronic device manufacturing and imaging systems.

In some embodiments, the lighting element may comprise a coaxial LED, including the Seiwa SMDA-100 GH, or any other coaxial LEDS including one or more of any other of the Seiwa SMDA LED series, the Seiwa SMDH series, the Seiwa SMD series, or any other kind of one or more similar coaxial LED commonly used in electronic device manufacturing and imaging systems. In other embodiments, a coaxial LED may not be used, and a, a ring light, an incandescent or fluorescent light, a halogen light, ambient light, or any kind of light source or combination of light sources commonly used in electronic device manufacturing and imaging systems may be used.

In some embodiments, sensing element 610 may include one or more image sensors. Such an image sensor may be a complementary metal-oxide-semiconductor (CMOS) sensors including a Seiwa BG160M integrated camera, a GigE integrated Camera BG series, a Toshiba BG160MCF integrated camera, or a Seiwa BG505LMCG/LMCF, or any other CMOS style integrated camera commonly used in electronic device manufacturing and imaging systems. In some embodiments, one or more sensing elements of sensing element 610 may be any one of a different type of sensor, including charge-coupled device (CCD) sensor, an active-pixel sensor, an infrared (IR) sensor, including a multispectral and hyperspectral Sensor, a LIDAR Sensor, or any other kind of imaging sensor commonly used in electronic device manufacturing and imaging systems.

In some embodiments sensing element 610 may include a lens that is of a high-resolution and a fixed focal length. In some embodiments the lensed may be intended for machine vision. In some embodiments, the lens may be a machine vision lens such as the Seiwa STV-3518-T3, or other similar lenses such as the STV-0918-T3, STV-1220-T3, STV-1618-T3, STV-2518-T3, and STV-7514-T3, or any other kind or brand of similar lens commonly used in electronic manufacturing systems and imaging systems.

In some embodiments, a sensing element 610 may have a horizontal field of view (FOV) of 65-75 mm, and a vertical FOV of 50-55 mm. In other embodiments, the sensing element may have a horizontal FOV of 60-80 mm, and a vertical FOV of 45-60 mm. In other embodiments, e.g., when using a line-scan camera, the entire substrate can be imaged at once.

The housing 612 may serve to arrange all the imaging element components into a monolithic package. One of ordinary skill in the art, having the benefit of this disclosure, will be able to design multiple housings to incorporate and support one or more of the multiple elements described above.

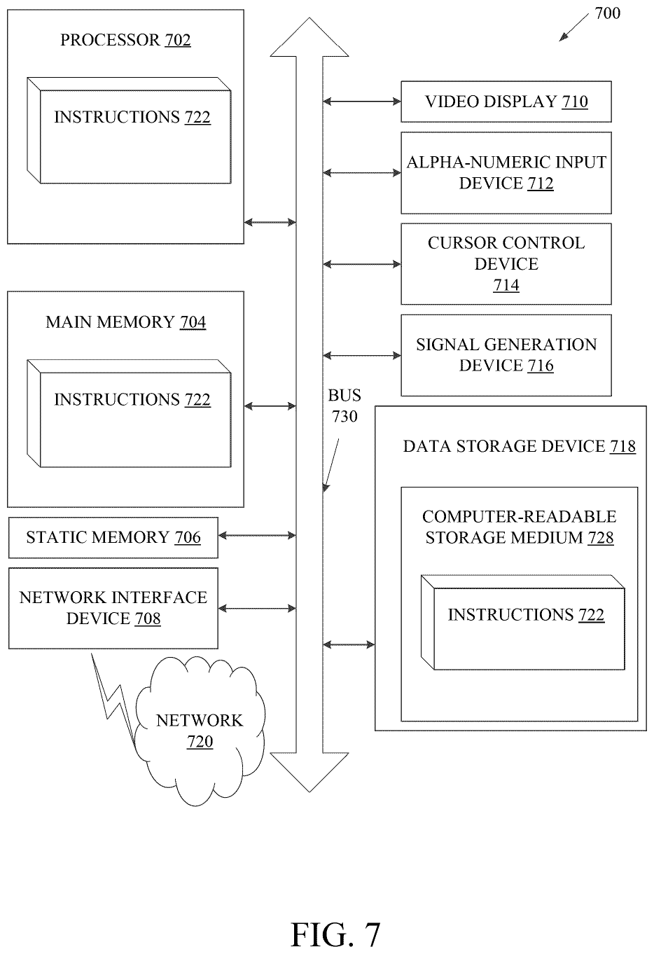

FIG. 7 illustrates an embodiment of a diagrammatic representation of a computing device associated with a substrate manufacturing system. In one implementation, the processing device 700 may be a part of any computing device of FIG. 1 or 3, or any combination thereof. Example processing device 700 may be connected to other processing devices in a LAN, an intranet, an extranet, and/or the Internet. The processing device 700 may be a personal computer (PC), a set-top box (STB), a server, a network router, switch or bridge, or any device capable of executing a set of instructions (sequential or otherwise) that specify actions to be taken by that device. Further, while only a single example processing device is illustrated, the term “processing device” shall also be taken to include any collection of processing devices (e.g., computers) that individually or jointly execute a set (or multiple sets) of instructions to perform any one or more of the methods discussed herein.

Example processing device 700 may include a processor 702 (e.g., a CPU), a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 718), which may communicate with each other via a bus 730.

Processor 702 represents one or more general-purpose processing devices such as a microprocessor, central processing unit, or the like. More particularly, processor 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 702 may also be one or more special-purpose processing devices such as an application specific integrated circuit (ASIC), a field programmable gate array (FPGA), a digital signal processor (DSP), network processor, or the like. In accordance with one or more aspects of the present disclosure, processor 702 may be configured to execute instructions (e.g. instructions 722 may include an image processing subsystem as seen in FIG. 3).

Example processing device 700 may further comprise a network interface device 708, which may be communicatively coupled to a network 720. Example processing device 700 may further comprise a video display 710 (e.g., a liquid crystal display (LCD), a touch screen, or a cathode ray tube (CRT)), an alphanumeric input device 712 (e.g., a keyboard), an input control device 714 (e.g., a cursor control device, a touch-screen control device, a mouse), and a signal generation device 716 (e.g., an acoustic speaker).

Data storage device 718 may include a computer-readable storage medium (or, more specifically, a non-transitory computer-readable storage medium) 728 on which is stored one or more sets of executable instructions 722. In accordance with one or more aspects of the present disclosure, executable instructions 722 may comprise executable instructions (e.g. implementing image processing subsystem 740 of FIG. 3).

Executable instructions 722 may also reside, completely or at least partially, within main memory 704 and/or within processor 702 during execution thereof by example processing device 700, main memory 704 and processor 702 also constituting computer-readable storage media. Executable instructions 722 may further be transmitted or received over a network via network interface device 708.

While the computer-readable storage medium 728 is shown in FIG. 7 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

It should be understood that the above description is intended to be illustrative, and not restrictive. Many other embodiment examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

The embodiments of methods, hardware, software, firmware or code set forth above may be implemented via instructions or code stored on a machine-accessible, machine readable, computer accessible, or computer readable medium which are executable by a processing element. “Memory” includes any mechanism that provides (i.e., stores and/or transmits) information in a form readable by a machine, such as a computer or electronic system. For example, “memory” includes random-access memory (RAM), such as static RAM (SRAM) or dynamic RAM (DRAM); ROM; magnetic or optical storage medium; flash memory devices; electrical storage devices; optical storage devices; acoustical storage devices, and any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment, embodiment, and/or other exemplarily language does not necessarily refer to the same embodiment or the same example, but may refer to different and distinct embodiments, as well as potentially the same embodiment.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such. Also, the terms “first,” “second,” “third,” “fourth,” etc. as used herein are meant as labels to distinguish among different elements and may not necessarily have an ordinal meaning according to their numerical designation.

A digital computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. The essential elements of a digital computer a central processing unit for performing or executing instructions and one or more memory devices for storing instructions and digital data. The central processing unit and the memory can be supplemented by, or incorporated in, special purpose logic circuitry or quantum simulators. Generally, a digital computer will also include, or be operatively coupled to receive digital data from or transfer digital data to, or both, one or more mass storage devices for storing digital data, e.g., magnetic, magneto-optical disks, optical disks, or systems suitable for storing information. However, a digital computer need not have such devices.

Digital computer-readable media suitable for storing digital computer program instructions and digital data include all forms of non-volatile digital memory, media and memory devices, including by way of example semiconductor memory devices, e.g., EPROM, EEPROM, and flash memory devices; magnetic disks, e.g., internal hard disks or removable disks; magneto-optical disks; CD-ROM and DVD-ROM disks.

Control of the various systems described in this specification, or portions of them, can be implemented in a digital computer program product that includes instructions that are stored on one or more non-transitory machine-readable storage media, and that are executable on one or more digital processing devices. The systems described in this specification, or portions of them, can each be implemented as an apparatus, method, or system that may include one or more digital processing devices and memory to store executable instructions to perform the operations described in this specification.

While this specification contains many specific embodiment details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A load lock system, comprising:
a load lock chamber comprising:
a substrate support device configured to support a substrate; and
an imaging element to capture image data reflective of a profile of the substrate; and
a computing subsystem configured to:
process the captured image data reflective of the substrate profile;
identify a feature associated with the substrate profile via the captured image data;
identify characteristic data of the feature associated with the substrate profile; and
generate a report on the feature associated with the substrate profile, wherein the report comprises the characteristic data of the feature, based on the processed image data.

2. The load lock system of claim 1, wherein the feature associated with the substrate profile comprises one or more of:
a misplacement of the substrate on the substrate support device comprising one or more of a translational misplacement or a rotational misplacement;
a body-level defect affecting a body of the substrate comprising one or more of a chip, a crack, or a break in the substrate; or
a deposition-level defect affecting a deposition on a surface of the substrate comprising one or more of a translational misplacement from an intended placement of the deposition, a rotational misplacement from an intended orientation of the deposition, or a nonconformity from an intended pattern of the deposition on the substrate.

3. The load lock system of claim 1, wherein the characteristic data of the feature comprises one or more of an indication of a presence of the feature, an indication of an absence of the feature, measurements associated with dimensions of the feature, an indication of a location of the feature, or an indication of a distance of the feature from a contour of the substrate profile.

4. The load lock system of claim 2, wherein generating the report on the misplacement of the substrate on the substrate support device comprises detecting substrate contours from the captured image data, and determining a position and orientation of the substrate relative to the load lock chamber based on the detected contours.

5. The load lock system of claim 2, wherein generating the report on the body-level defect affecting the body of the substrate comprises:
detecting substrate contours from the captured image data;
detecting conformities within the substrate contours;
detecting nonconformities within the substrate contours;
comparing, for each nonconformity detected, data associated with the nonconformities against data associated with the conformities, to determine a level of nonconformity; and
comparing, for each nonconformity, the level of nonconformity against a threshold, to determine whether to report a presence of the nonconformity.

6. The load lock system of claim 2, wherein generating the report on the deposition-level defect affecting the deposition on the surface of the substrate comprises:
detecting deposition contours from the captured image data;
detecting conformities within the deposition contours;
detecting nonconformities within the deposition contours;
comparing, for each nonconformity detected, data associated with the nonconformities against data associated with the conformities, to determine a level of nonconformity; and
comparing, for each nonconformity, the level of nonconformity against a threshold, to determine whether to report a presence of the nonconformity.

7. The load lock system of claim 1, wherein the computing subsystem is configured to process the captured image data using a trained machine learning model to identify the feature associated with the substrate profile comprising one or more of a misplacement of the substrate on the substrate support device, a body-level defect affecting a body of the substrate, or a deposition-level defect affecting a deposition on a surface of the substrate.

8. The load lock system of claim 1, wherein the imaging element comprises an image sensor, a lens, and a lighting element.

9. The load lock system of claim 1, wherein the load lock chamber further comprises a plurality of imaging elements configured to capture image data reflective of the profile of the substrate, wherein the plurality of imaging elements are arranged a distance from each other, such that each imaging element of the plurality of imaging elements is configured to capture image data reflective of a unique portion of the profile of the substrate.

10. The load lock system of claim 1, wherein the computing subsystem is further configured to transmit the report on the feature associated with the substrate profile to a subsystem such that a remedial action is taken to eliminate the feature from the profile of future processed substrates, wherein the remedial action to eliminate the feature is taken based on the characteristic data of the feature.

11. The load lock system of claim 10, wherein the remedial action to eliminate the feature is one or more of adjusting a position of a substrate in a process chamber, calibrating a substrate transfer mechanism, or modifying process parameters associated with a process associated with the substrate.

12. A method for identifying a feature of a substrate profile, comprising:
capturing image data reflective of a substrate profile of a substrate within a load lock chamber, wherein the load lock chamber comprises a substrate support device configured to support a substrate and an imaging element to capture image data reflective of a profile of the substrate;
processing the captured image data via a computing subsystem;
identifying a feature associated with the substrate profile via the captured image data;
identifying characteristic data of the feature associated with the substrate profile; and
generating a report on the feature associated with the substrate profile, wherein the report comprises characteristic data of the feature, based on the processed image data.

13. The method of claim 12, wherein the feature associated with the substrate profile comprises one or more of:
a misplacement of the substrate on the substrate support device comprising one or more of a translational misplacement or a rotational misplacement;
a body-level defect affecting a body of the substrate comprising one or more of a chip, a crack, or a break in the substrate; or
a deposition-level defect affecting a deposition on a surface of the substrate comprising one or more of a translational misplacement from an intended placement of the deposition, a rotational misplacement from an intended orientation of the deposition, or a nonconformity from an intended pattern of the deposition on the substrate.

14. The method of claim 12, wherein the characteristic data of the feature comprises one or more of an indication of a presence of the feature, an indication of an absence of the feature, measurements associated with dimensions of the feature, an indication of a location of the feature, or an indication of a distance of the feature from a contour of the substrate profile.

15. The method of claim 13, wherein generating the report on the misplacement of the substrate on the substrate support device comprises detecting substrate contours from the captured image data, and determining a position and orientation of the substrate relative to the load lock chamber based on the detected contours.

16. The method of claim 13, wherein generating the report on the body-level defect affecting the body of the substrate comprises:
detecting substrate contours from the captured image data;
detecting conformities within the substrate contours;
detecting nonconformities within the substrate contours;
comparing, for each nonconformity detected, data associated with the nonconformities against data associated with the conformities, to determine a level of nonconformity; and
comparing, for each nonconformity, the level of nonconformity against a threshold, to determine whether to report a presence of the nonconformity.

17. The method of claim 13, wherein generating the report on the deposition-level defect affecting the deposition on the surface of the substrate comprises:
detecting deposition contours from the captured image data;
detecting conformities within the deposition contours;
detecting nonconformities within the deposition contours;
comparing, for each nonconformity detected, data associated with the nonconformities against data associated with the conformities, to determine a level of nonconformity; and
comparing, for each nonconformity, the level of nonconformity against a threshold, to determine whether to report a presence of the nonconformity.

18. The method of claim 12, wherein the computing subsystem is configured to process the captured image data using a trained machine learning model to identify the feature associated with the substrate profile comprising one or more of a misplacement of the substrate on the substrate support device, a body-level defect affecting a body of the substrate, or a deposition-level defect affecting a deposition on a surface of the substrate.

19. The method of claim 12, wherein the imaging element comprises an image sensor, a lens, and a lighting element.

20. The method of claim 12, wherein the load lock chamber further comprises a plurality of imaging elements configured to capture image data reflective of the profile of the substrate, wherein the plurality of imaging elements are arranged a distance from each other, such that each imaging element of the plurality of imaging elements is configured to capture image data reflective of a unique portion of the profile of the substrate.
